(19) United States
(12) Patent Application Publication
(10) Pub. No.: US 2014/0343967 A1
(43) Pub. Date: Nov. 20, 2014

(54) Methods to Improve Workflow by Automatically Adding Patient Identification

(71) Applicant: Welch Allyn, Inc., Skaneateles Falls, NY (US)

(72) Inventor: Steven D. Baker, Beaverton, OR (US)

(73) Assignee: Welch Allyn, Inc., Skaneateles Falls, NY (US)

(21) Appl. No.: 14/278,891

(22) Filed: May 15, 2014

Related U.S. Application Data
(60) Provisional application No. 61/823,486, filed on May 15, 2013.

(51) Int. Cl. G06F 19/00

(52) U.S. Cl. CPC G06F 19/323
USPC 705/3

(57) ABSTRACT

A method implemented on an electronic device for pairing patient records with a patient identifier includes programming a smart tag with the patient identifier. The smart tag is attached on an item associated with a patient. The patient identifier is read from the smart tag. The reading of the patient identifier from the smart tag activates a software application on the electronic device for reading the patient records. After the patient identifier is obtained, one of the patient records is automatically accessed on the electronic device using the patient identifier.

### BACKGROUND

A common workflow in a medical facility is to obtain vital signs measurements from patients. Typically, when the vital signs measurements are taken, the vital signs measurements are entered into a medical record for the patient. In order to enter the vital signs measurements into a medical record for the patient, the patient must be properly identified.

In a medical facility, patients may be identified by different methods. One method of identifying a patient is to search a list of patients admitted to the medical facility and match the patient to a patient on the list. Another method is to read an identification bracelet that may be worn by the patient.

These methods and other methods of identifying patients may be problematic for one or more reasons. Errors may be made when matching patients to a list of patients and the matching process may be cumbersome and time consuming. Furthermore, not all patients may wear identification bracelets and for those patients that do wear the identification bracelets, the identification bracelets may be difficult to reach without disturbing the patient.

### SUMMARY

Embodiments of the disclosure are directed to a method implemented on an electronic device for pairing patient records with a patient identifier, comprising: programming a smart tag with the patient identifier; attaching the smart tag on an item associated with a patient; reading the patient identifier from the smart tag, the reading of the patient identifier from the smart tag activating a software application on the electronic device for reading the patient records; and after the patient identifier is obtained, on the electronic device, automatically accessing one of the patient records using the patient identifier.

In another aspect, a method implemented on an electronic device for pairing patient records with a patient identifier comprises: using the electronic device to access a server computer to obtain the patient identifier; after the patient identifier is obtained, touching the electronic device to a smart tag, the smart tag being connected to a patient monitor device, the touching of the electronic device to the smart tag transferring the patient identifier to the smart tag; after the patient identifier is transferred to the smart tag, automatically obtaining one of the patient records from the server computer, the one patient record being identified by the patient identifier; and displaying the patient record on the patient monitor device.

In yet another aspect, a system for accessing patient records comprises: a smart tag, the smart tag storing a patient identifier, the smart tag being a radio frequency identification (RFID) device or a near-field communication (NFC) device; and an electronic device, the electronic device configured to read the patient identifier from the smart tag, the electronic device including software for interpreting data from the smart tag, the electronic device providing connectivity to a patient data server computer, wherein the connectivity is automatically provided when the patient identifier is read from the smart tag, wherein the connectivity permits a patient record to be obtained from the patient data server computer based on the patient identifier and wherein the electronic device is configured to display the patient record on the electronic device.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system that supports a workflow for automatically obtaining a patient identifier.

FIG. 2 shows an example flowchart for obtaining a patient identifier from a smart tag.

FIG. 3 shows an example flowchart for transferring a patient identifier from an electronic device to a smart tag connected to a patient monitor.

FIG. 4 shows an example flowchart for obtaining a patient identifier from a smart tag connected to a patient monitor.

FIG. 5 shows an example flowchart for obtaining a patient identifier at a patient monitor from a smart tag on a patient chart.

FIG. 6 shows an example flowchart for updating a patient record at a patient monitor using a patient identifier.

FIG. 7 shows an example flowchart for pairing a sensor device to a computer.

FIG. 8 shows example physical components of the patient monitor of FIG. 1.

### DETAILED DESCRIPTION

The present disclosure is directed to systems and methods for improving medical workflows by automatically obtaining a patient identifier that can be used to access a medical record for a patient. In some example systems and methods, a radio frequency identification device (RFID) is programmed with the patient identifier (patient ID). One example RFID device that supports bi-directional wireless communication is a near-field communication (NFC) tag and may be called a “smart tag.” The RFID device, or smart-tag, is placed at a convenient location near the patient. In one example, the smart tag is placed on a patient chart. In other examples, the smart tag may be placed at locations such as a patient bedside, door frame, patient monitor, wrist ID or pendant. Other locations are possible.

The smart tag may also include a sensor device that stays with the patient. The sensor device may be attached to the smart tag or may be placed in a same housing as the smart tag. For example, a wrist ID bracelet may include a sensor device such as an accelerometer or pressure transducer that measures the patient's pulse rate.

When a clinician scans the smart tag, typically with an electronic device such as a smart telephone or tablet, the patient ID is read from the smart tag. The process of reading the patient ID activates a software application on the smart telephone. When the software application is activated, a connection is made between the smart telephone and a server computer, such as a server computer that is part of an electronic health records (EHR) system. A patient record corresponding to the patient ID is then obtained from the EHR system and displayed on the smart telephone for viewing and/or updating. Other electronic devices besides a smart telephone may be used, such as tablets, slates, laptops, etc. In this disclosure, a server computer that is part of an EHR system is referred to as an EHR server computer.

In other examples, the patient ID may be encoded using a bar code. Other methods of encoding the patient ID are possible.

The systems and methods may also be used with a patient monitor device, typically for a patient in a hospital. Using the systems and methods, the patient monitor is connected to the RFID device, typically via a hard-wired connection (though the patient monitor could use an NFC tag and an embedded NFC writer to connect to an NFC tag). The patient monitor typically has access to the patient ID and its own radio addresses, such as the Bluetooth address. Using the hard-wired connection (for RFID) or an NFC writer (smart tag), the NFC/RFID device on the patient monitor is programmed with the patient ID and possibly other information, such as the monitor's Bluetooth address or another globally unique ID (GUID). A clinician may then use an electronic device such as a smart telephone to scan the NFC/RFID device on the patient monitor, obtain the patient ID from the NFC/RFID device, activate a software application on the smart telephone, establish a connection to the EHR system, access a patient record from the EHR system corresponding to the patient ID and optionally update the patient record. The updated patient record may be sent to the patient monitor, via the NFC/RFID device. When the patient monitor has EHR connectivity, the patient monitor may then store the updated patient record in the EHR system.

In some examples, the patient monitor may not have access to the patient ID and a smart phone may be used to provision the patient monitor's smart tag with the patient ID, for example when a new patient is admitted to a hospital room. In an alternative method, the smart telephone may obtain the patient ID through access to the EHR system, an admissions/discharge/transfer (ADT) server computer, manual entry, reading the patient ID from another smart tag (for example a smart tag on the patient chart) or through another method. After the patient ID is obtained, a near-field communication (NFC) writer application is started and the clinician may move the smart telephone into close proximity with the RFID device on the patient monitor. Moving the smart telephone into close proximity with the RFID device on the patient monitor transfers the patient ID to the patient monitor. The data is transferred wirelessly using, for example, radio frequency (RF) communication to the smart tag attached to the monitor, as discussed later herein. The patient ID is turn be read by the patient monitor's microprocessor and may then be used to obtain and/or update a patient record from a server computer. When the patient record is obtained, the patient record may be displayed on the patient monitor.

When the patient monitor has the patient ID and the patient monitor receives new patient data, the patient monitor may use the patient ID to update the patient record on an EHR server computer. Alternatively, for example, at a later time when new patient data is received, the new patient data may be uploaded to the smart tag on the patient monitor and read by the smart telephone. Because the patient data includes the patient ID, the smart telephone may inspect a data payload from the packet in which the patient data is received, determine that a data type in the data payload is registered for an EHR application and start the EHR application. When the EHR application is started, the patient data is transmitted to the patient record (based on the patient ID in the EHR server computer. The EHR application permits a clinician to confirm the patient data or amend the patient data prior to transmission to the EHR server computer.

In some examples, the smart telephone may be used to obtain the patient ID from a smart tag on a patient chart or a smart tag at another location near the patient. When the patient ID is obtained, the clinician may move the smart telephone to close proximity with an RFID device on the patient monitor. When the smart telephone is moved to close proximity with the RFID device on the patient monitor, the patient ID is transferred to the patient monitor. An electronic record for the patient may then be obtained from the server computer, using the patient ID, and displayed on the patient monitor.

In addition to accessing patient records using the patient ID, the patient records may also be updated with new data. For example, the smart telephone may be used to read medical data from a medical sensor device attached to the patient and displayed on the smart telephone. The smart telephone may also be used to read medical data from a patient monitor. The clinician may optionally view, modify or approve the medical data. When the medical data is obtained, the smart telephone may be moved into close proximity with a smart tag on the patient chart or a smart tag on another item located near the patient. When the smart telephone is moved into close proximity with the smart tag on the patient chart, the patient ID is transferred to the smart telephone. In some examples, when the smart telephone obtains the patient ID, a connection is automatically made to the server computer and a patient record is displayed on the smart telephone. The medical data from the medical sensor device may then be appended to the patient record on the smart telephone.

In some examples, the clinician may manually enter patient data into the patient record, for example, when medical data from the medical sensor device is not available via a radio frequency (RF) connection. In other examples, the medical sensor device may have the patient ID and transmit the patient ID and the medical data to the smart telephone. The patient record on the smart telephone may then be transmitted to a server computer, for example to the EHR server computer. In other examples, when the medical data is displayed on the smart telephone and the smart telephone obtains the patient ID, a connection is automatically made to the EHR server computer and the EHR server computer is updated with the medical data.

As explained herein, the systems and methods may encompass different types of RFID devices and different types of communication between the smart telephone and an RFID device. For example, the RFID device may support NFC or may be part of a personal area network (PAN). One example of a PAN is a body area network (BAN), in which the RFID device may be attached to the body of the patient. U.S. patent application Ser. No. 12/723,726, filed on Mar. 26, 2010, discusses pairing of physiological sensor devices for a patient in a PAN/BAN and is incorporated by reference it its entirety herein.

Data transfer may be accomplished via NFC or another method such as Bluetooth Low Energy (BTLE) or ultra-wide band (UWB). For ranging methods such as NFC, BTLE and UWB, the smart telephone typically does not need to make physical contact with the smart tag for data transfer to occur. Instead, the smart telephone only needs to be in close proximity with the smart tag in order for data transfer to occur. If there are multiple smart tags in range of the smart telephone, a user interface on the smart telephone may prompt the clinician to select a particular smart tag.

In this disclosure, NFC may refer to any apparatus that can transfer data as a function of detecting proximity to another device. For example, BTLE when used in whisper mode may be used to determine that two devices with BTLE are within approximately 1 meter of each other and then provide the same functions as NFC, compliant with ISO/IEC 14443. For non-ranging solutions such as Bluetooth, a method to verify that the correct devices are connecting may be used. For example, using an accelerometer in each device, correlating a detected acceleration from having the connecting devices make contact.

Another use including NFC is to ensure that a wireless sensor makes the correct connection to a patient monitor or computer. In a typical scenario, there may be multiple sensors and multiple computers on a hospital floor. If there is a one-to-one Bluetooth pairing between the sensors and computers and the sensors and computers are mixed up, then the chosen sensor will not connect to the proper computer. A solution for this is to pair all the sensors with all the computers. However, in this case, the sensor reading data from a first patient may connect to a different computer associated with a second patient, causing data from the first patient to be entered.

One solution is to keep the sensor in connectable mode, but to disable automatic connections. With this, the sensor and computer will not connect automatically; rather the connection must be initiated from one of the two devices. Assuming the sensor is in connectable mode, then the user may select the ID of the chosen sensor from a menu on the computer, the computer sends a connection request to the sensor and then this connection request is accepted by the sensor. This solution improves the confidence that the data are correctly handled, but does not fully solve the problem as it is still possible that a sensor is mislabeled or that the clinician accidentally selects an incorrect sensor and that sensor is in range, thereby initiating a connection to an incorrect sensor.

In yet another embodiment, an NFC tag is applied to the computer that contains a globally unique identifier (GUID) and that GUID is provisioned into the computer. Now the connection process replaces the clinician's selection of a sensor with this process: Clinician touches the sensor to the NFC tag and the sensor reads the GUID. The sensor initiates a connection to the computer (based on its list of paired devices) and once the sensor makes a connection to the computer, the sensor transmits the GUID. The application on the computer ensures that the transmitted GUID matches the received GUID for confirmation that this proximal sensor is the correct sensor with which to have a communication session. If the GUIDs do not match, then the communication is terminated.

To further improve the process, the Bluetooth address of the computer (i.e., a media access control (MAC) address) can be included. This may be done for example by programming the computer's Bluetooth address into the NFC tag or by provisioning the sensor with a mapping from GUID to Bluetooth address. Assuming the computer's Bluetooth address is used (NOTE: the computer's Bluetooth address is also a GUID and a computer with a Bluetooth radio is considered to be provisioned with a GUID) the clinician touches the sensor to the NFC tag, reading the computer's Bluetooth address. The sensor initiates a connection to the computer using that computer's Bluetooth address read from the GUID. In the event the sensor is not paired with the computer, this action spawns a pairing process. The system also works if the sensor has the NFC tag and the computer (or patient monitor or other device) has an NFC reader. The NFC tag on the patient monitor may additionally be programmed with the patient ID and used as described previously. The NFC tag may be replaced with other similar solutions that provide short-range RF communication, where short range is typically less than one meter and may be as close as several millimeters.

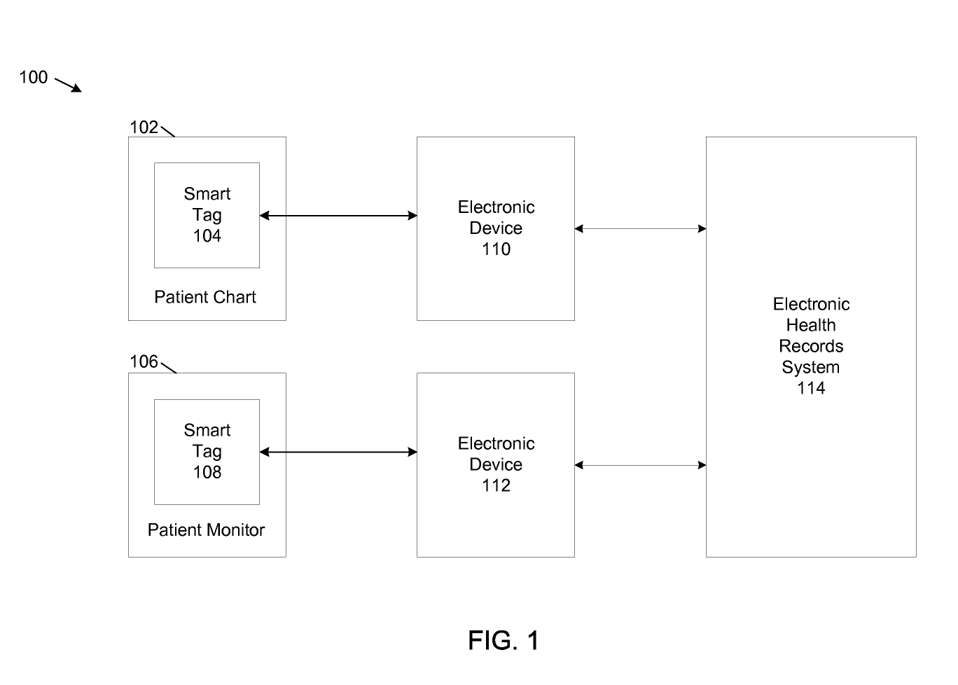

FIG. 1 shows an example system 100 that supports a workflow for automatically obtaining a patient ID. The system 100 includes a patient chart 102, a smart tag 104 attached to the patient chart 102, a patient monitor device 106, a smart tag 108 attached to patient monitor device 106, electronic devices 110, 112 and an electronic health records (EHR) system 114.

In the example system 100, the smart tags 104, 108 are typically NFC devices. NFC is a wireless, non-contact use of electromagnetic waves to transfer data. Other methods of transferring data using include wireless communication standards and protocols such RFID, Bluetooth, BTLE, UWB, ANT, ZigBee, Medical Implant Communication Service (MICS) Body Area Network (BAN) and (Medical Body Area Network (MBAN). MBAN is a specific implementation of a BAN that uses frequencies allocated by the FCC in Report and Order FCC 12-54. Other methods of transferring data wirelessly are possible. The NFC device may be part of an MBAN that transfers data among sensors to one aggregator and then uses NFC for an uplink (MBANs are required to uplink data using something other than MBAN). In the example system 100, smart tag 104 is physically attached to patient chart 102. Patient chart 102 is located near a patient in a medical facility, typically a hospital or a doctor's office. In lieu of patient chart 102, the smart tag 104 may be at any location in close proximity to the patient, for example on the patient's bedframe. Because the patient chart 102 is conveniently located near the patient, a clinician can easily access information, such as a patient ID that may be programmed on smart tag 104.

The electronic device 110 is an electronic computing device with NFC capability. Typically, electronic device 110 is a smart telephone. However, other electronic devices such as personal computers, tablet computers, etc. may be used. The electronic device 110 may include a software application that permits access and display of a patient health record. For example, the software application may permit a clinician to access the patient health record from a server computer in an EHR system and display the patient health record on electronic device 110.

The electronic device 110 may use the NFC capability to obtain the patient ID for the patient from smart tag 104. In some examples, when electronic device 110 obtains the patient ID, the software application automatically accesses the patient record from the EHR system and displays the patient record on electronic device 110.

The patient monitor device 106 is an electronic computing device that displays vital signs data for a patient. The patient monitor device 106 is typically used for a patient in a hospital. Patient monitor device 106 typically has access to a server computer that includes patient identification information. For example, patient monitor device 106 may have access to an ADT server computer in the hospital. Patient monitor device 106 may be configured to obtain a patient ID from the ADT server computer or from a similar type of server computer. An example of patient monitor device 106 is the Connex® Vital Signs Monitor from Welch Allyn, Inc. of Skaneateles Falls, N.Y.

The smart tag 108 is an RFID device that is attached to patient monitor device 106 and that typically may have a hard-wired connection to patient monitor device 106. If a smart-tag is used, then either a hard-wired connection or an NFC connection to the patient monitor device 106 may be used. When the patient monitor device 106 obtains the patient ID, the patient monitor device 106 may be configured to program smart tag 108 with the patient ID. When smart tag 108 is programmed with the patient ID, the patient ID may be accessible to a clinician via electronic device 112.

Electronic device 112 is an electronic computing device with RFID capability. In some examples, electronic device 112 may be the same physical device as electronic device 110. In other examples, for example when patient chart 102 and patient monitor device 106 are in different physical locations, electronic device 110 and electronic device 112 are different physical devices.

Electronic device 112 includes a software application that permits patient records to be obtained from the EHR system 114 and that permits the patient records to be displayed on electronic device 112. When electronic device 112 comes into close proximity with the smart tag 108, the patient ID is transferred to electronic device 112. For example, the patient ID may be transferred via NFC, BLE or a similar technology. In some examples, when electronic device 112 obtains the patient ID, the software application automatically accesses the EHR system and obtains a patient record corresponding to the patient ID. In other examples, the clinician manually requests the patient record based on the patient ID.

The EHR system 114 provides patient records for a plurality of patients in the medical facility. The EHR system 114 may comprise one or more server computers and data stores. The EHR system 114 may be located at the medical facility or at a different location.

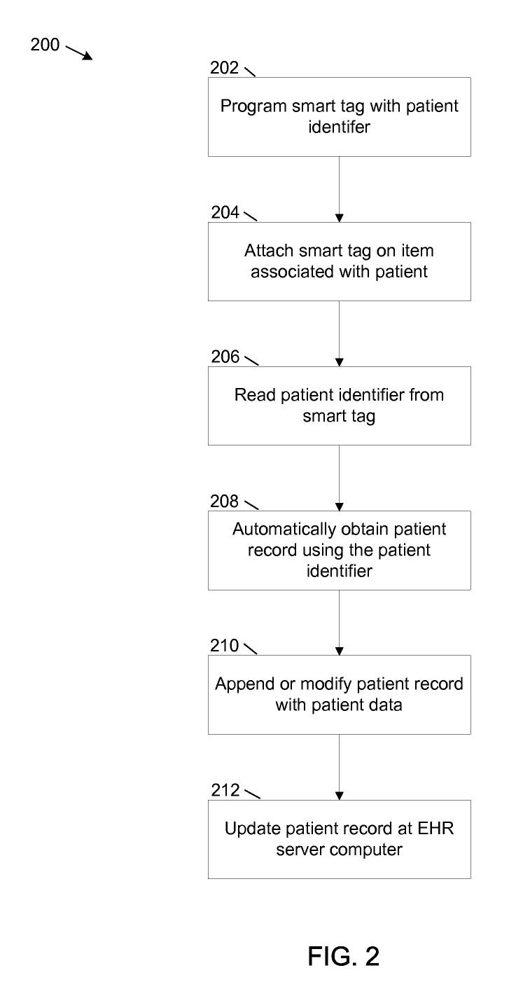

FIG. 2 shows an example flowchart for a method 200 for obtaining a patient ID from a smart tag. At operation 202, the smart tag is programmed with patient information, including the patient ID. Typically, the smart tag is programmed with the patient ID when a patient is admitted to a medical facility. A patient chart is created for the patient when the patient is first admitted to the medical facility and the smart tag is typically programmed with the patient ID at the same time.

At operation 204, the smart tag is attached to the patient chart. Because the patient chart typically stays with the patient, or at a location near the patient, the patient chart is easily accessible to a clinician that is caring for the patient. In some examples, the smart tag in placed in a location other than the patient chart, but near a location of the patient. For example, the smart tag may be placed on a bed, on a door frame on a patient monitor, etc. Other locations are possible.

At operation 206, the patient ID is read from the smart tag. Typically, when a clinician examines the patient, the clinician checks the patient chart. The clinician may carry an electronic device, such as a smart telephone with RFID capability. For example, the smart telephone may be configured with NFC, Bluetooth, BLE or a similar technology. When the clinician moves the smart telephone into close proximity with the smart tag, the patient ID is transferred to the smart telephone.

At operation 208, a patient record is automatically obtained using the patient ID. In some examples, the smart telephone includes a software application for obtaining and displaying patient records. The software application uses the patient ID as a key to obtain a patient record for the patient. In some examples, when the patient ID is transferred to the smart telephone from the smart tag, the software application automatically uses the patient ID to obtain and display the patient record. In other examples, the clinician manually initiates obtaining the patient record from the smart telephone.

Typically, before a software application is started, a data type is determined for the software application. For NFC, messages are in the NFC Data Exchange Format (NDEF). NDEF is used to encapsulate typed data such as MIME-type media, a URL or a custom application payload. When the operating system of the electronic device doesn't recognize a data type for an NFC message, the operating system determines whether a software application has subscribed to a particular data type. When a software application has subscribed to the data type, the operating system starts that software application. The software application at operation 208 is started using the patient ID as a parameter, including possibly some specific configurations for the software application included in a NFC payload of the NFC message.

At operation 210, the patient record is modified or appended with patient data. The patient data may be obtained at the electronic device from a medical sensor device or from another source, such as manual entry of patient notes or diagnostic codes. At operation 212, the electronic device sends the modified or appended patient record to an EHR server computer to update the patient record at the EHR server computer. The EHR server computer may be part of EHR system 114.

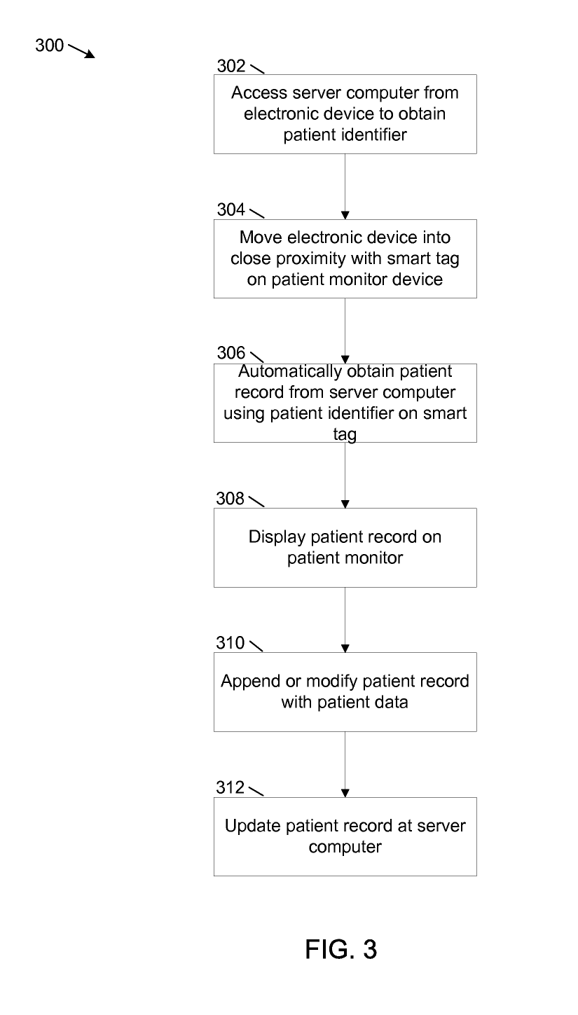

FIG. 3 shows an example flowchart for a method 300 for transferring a patient identifier from an electronic device to a smart tag connected to a patient monitor.

At operation 302, an electronic device accesses a server computer to obtain a patient ID for a patient. The electronic device, for example electronic device 112, is typically a smart telephone used by a clinician or other medical personnel. The server computer is a server computer in an EHR system, for example in EHR system 114. The electronic device 112 may include a software application that permits access to the EHR system 114.

At operation 304, electronic device 112 is moved into close proximity with a smart tag that is attached to a patient monitor. For example, electronic device 112 is moved to close proximity to smart tag 108. Smart tag 108 is physically connected to patient monitor device 106. Both electronic device 112 and smart tag 108 have RFID capability. When electronic device 112 is moved into close proximity with smart tag 108, the patient ID obtained by electronic device 112 is transferred to smart tag 108.

At operation 306, a patient record for the patient corresponding to the patient ID is automatically obtained from the server computer. Because the smart tag 108 is connected to patient monitor device 106, the patient ID is also transferred from smart tag 108 to patient monitor device 106. In some examples, a software application on patient monitor device 106 automatically initiates a request from patient monitor device 106 to the server computer to obtain the patient record. In other examples, a clinician or other medical personnel manually initiates the request via a control on patient monitor device 106. At operation 308, the patient record is displayed on the patient monitor.

At operation 310, the patient record is modified or appended with patient data. The patient data may be obtained at patient monitor device 106 from a medical sensor device or from another source, such as manual entry of patient notes or diagnostic codes. At operation 312, patient monitor 106 sends the modified or appended patient record to the server computer to update the patient record at the server computer.

In an alternative workflow (not shown in FIG. 3), patient monitor device 106 already has a patient ID stored. A user may be queried to confirm if a new patient ID should be used and replace the existing patient ID stored. If a determination is made that the new patient ID should be used, patient data corresponding to the existing stored patient ID is deleted. When the existing patient ID is replaced with the new patient ID at patient monitor device 106, patient monitor device 106 may access a patient record corresponding to the new patient ID and append recently acquired patient data to the patient record. In addition, a clinician may obtain a historical patient record, corresponding to the new patient ID, at any time.

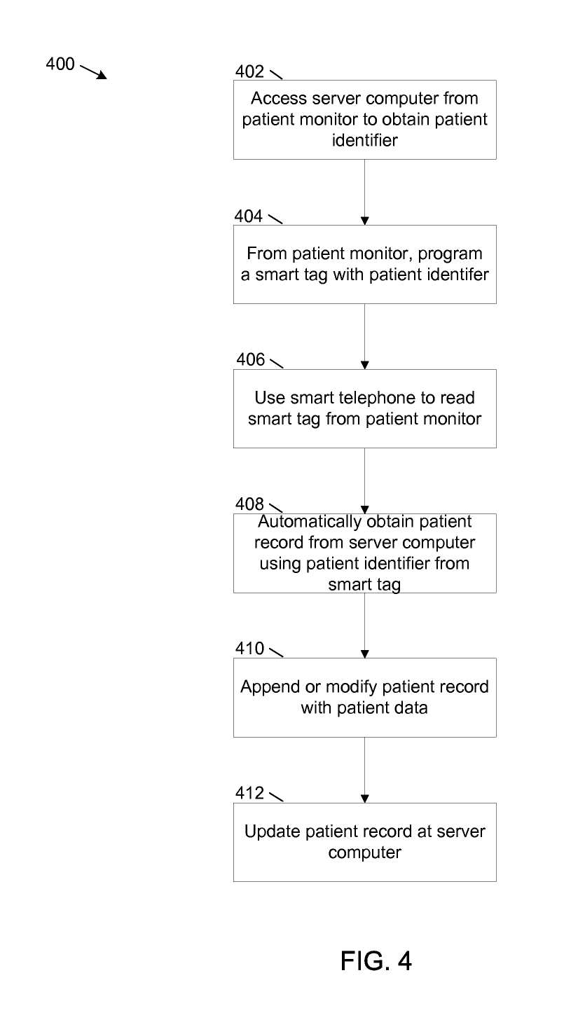

FIG. 4 shows an example flowchart for a method 400 for obtaining a patient ID from a smart tag connected to a patient monitor. When the patient ID is obtained from the smart tag, a clinician attending a patient may access a patient record for the patient using the patient ID.

At operation 402, a patient ID is obtained at the patient monitor from a server computer. The patient ID is for a patient being monitored at the patient monitor. The patient monitor typically maintains a connection to a server computer in an EHR system. The connection may be used to send medical data from the patient monitor to the EHR system. The connection may also be used to obtain a patient ID for the patient. In the example method 400, patient monitor device 106, smart tag 108, electronic device 112 and EHR system 114 are used.

At operation 404, patient monitor device 106 programs RF tag 108 with the patient ID. RF tag 108 is attached to patient monitor device 106 and may be hard-wired to patient monitor device 106 in the case of an RFID tag or have a wireless connection to patient monitor device 106 in the case of an NFC tag.

At operation 406, electronic device 112 reads the patient ID from patient monitor device 106. Optionally, electronic device 112 may read recent patient data from patient monitor device 106 via smart tag 108. Electronic device 112 is typically a smart telephone. The smart telephone typically includes functionality for NFC, Bluetooth or Bluetooth LE. The smart telephone also includes a software application for accessing and displaying patient records.

At operation 408, a patient record for the patient is automatically obtained from EHR system 114 using the patient ID from the smart telephone. When the patient ID is obtained from the smart tag, the software application automatically connects to EHR system 114 and obtains a patient record corresponding to the patient ID. The patient record is displayed on the smart telephone using the software application.

At operation 410, the patient record is modified or appended with patient data. The patient data may be obtained at the smart telephone from a medical sensor device or from another source, such as manual entry of patient notes or diagnostic codes. At operation 412, the smart telephone sends the modified or appended patient record to the server computer to update the patient record at the server computer.

The software application may require a user to be logged onto a clinical system to verify access rights to patient data and the software application may provide a specific screen, depending on the clinician's identity or role, e.g., doctor or nurse. As an example, the nurse's view may default to adding new vital signs data while the doctor's view may default to patient interview and diagnosis screens. A view may be an empty record in which the clinician can enter data. Data entry may be manual or automatic. For manual data entry, the clinician may, for example, use a thermometer to take a temperature for a patient, read a temperature value on the thermometer and enter the temperature data. For automatic data entry, the clinician may, for example, use a thermometer to take a temperature and bring the smart telephone in close proximity to the thermometer, allowing NFC to transfer the temperature to the smart telephone. The NDEF is decoded by the software application and determined to contain temperature data. The temperature data is then populated into the patient record. Regardless of how physiological data are entered, the software application on the smart telephone may update the server computer with temperature and other vital signs data for the patient.

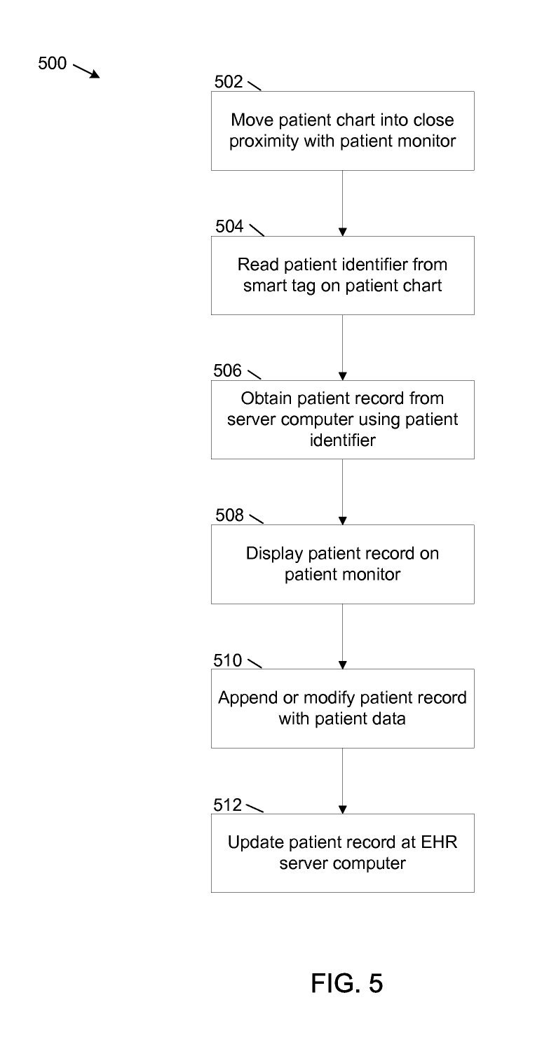

FIG. 5 shows an example flowchart for a method 500 for obtaining a patient ID at a patient monitor from a smart tag on a patient chart. The smart tag on the patient chart is programmed with the patient ID, typically when the patient is admitted to a medical facility for treatment. For method 500, the patient monitor includes NFC functionality. The NFC functionality permits the patient monitor to read the patient ID from the smart tag on the patient chart.

At operation 502, the patient chart is moved to close proximity of the patient monitor. Close proximity is a proximity close enough to establish RF communication between the smart tag on the patient chart and the patient monitor, typically a few centimeters.

At operation 504, when the patient monitor is in close proximity of the patient monitor, the patient monitor reads the patient ID from the smart tag on the patient chart.

At operation 506, a patient record is obtained at the patient monitor from a server computer. The server computer is part of an EHR system. In some examples, the patient monitor is configured to automatically obtain the patient record when the patient monitor reads the patient ID. In other examples, a clinician or other medical personnel may need to initiate a request for the patient record from the patient monitor.

At operation 508, the patient record is displayed on the patient monitor.

At operation 510, the patient record is modified or appended with patient data. The patient data may be obtained at the patient monitor from a medical sensor device or from another source, such as manual entry of patient notes or diagnostic codes. At operation 512, the patient monitor sends the modified or appended patient record to the server computer to update the patient record at the server computer.

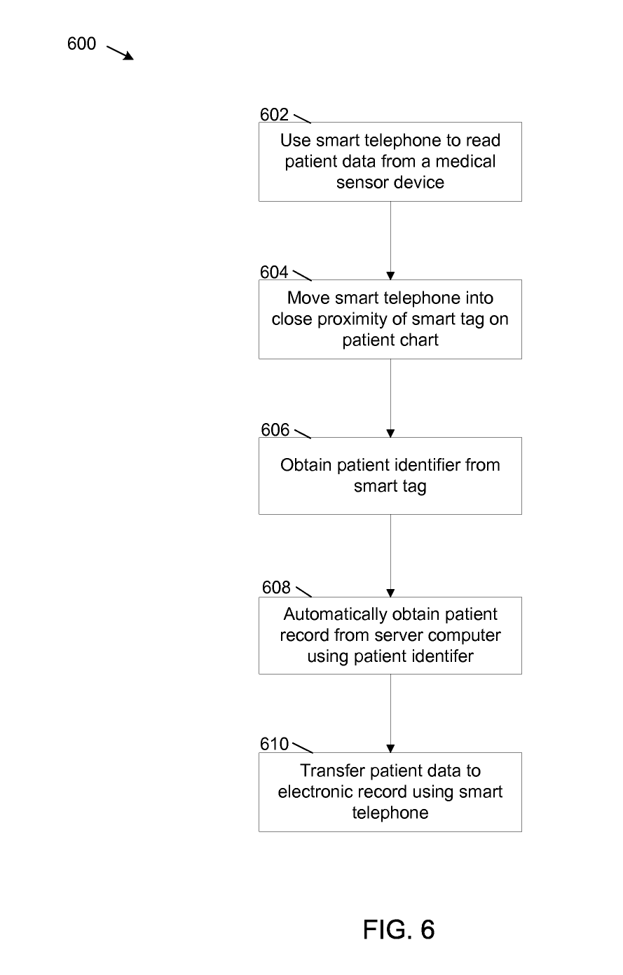

FIG. 6 shows an example flowchart for a method 600 for updating a patient record using a patient ID. The method 600 permits the patient record to be updated with medical data from a medical sensor device when the medical sensor device does not have a connection to the EHR server. The sensor may be a single parameter sensor such as an SPO2 sensor, NIBP sensor, temperature sensor or the like. The sensor may also be a multi-parameter device incorporating multiple sensors, such as patient monitor 106.

At operation 602, an electronic device is used to read data from a medical sensor device attached to a patient. The electronic device is typically a smart telephone with a software application for reading data from the medical sensor device.

At operation 604, the smart telephone is moved into close proximity of a smart tag located, for example, on a patient chart.

At operation 606, the smart telephone obtains the patient ID from the patient chart smart tag. The patient ID is obtained from the patient chart using an RF technology such as NFC. Alternatively, a clinician may manually enter the medical data into the smart telephone or may use an ADT interface application to obtain the patient ID. In examples where the smart tag is attached to the medical sensor device, the patient ID may be transmitted along with the patient data in operation 602, in which case operations 604 and 606 are not required.

At operation 608, after the patient ID is obtained, a connection is made between the smart telephone and a server computer in EHR system 114 and a patient record associated with the patient ID is transferred to the smart telephone. In some examples, the patient record is obtained automatically after the patient ID is obtained. In other examples, a clinician or other medical personnel initiates obtaining the patient record. In other examples, the patient record is accessed (to permit transfer of patient data in operation 610), but the patient record is not obtained.

At operation 610, patient data is transferred to the patient record using the smart telephone.

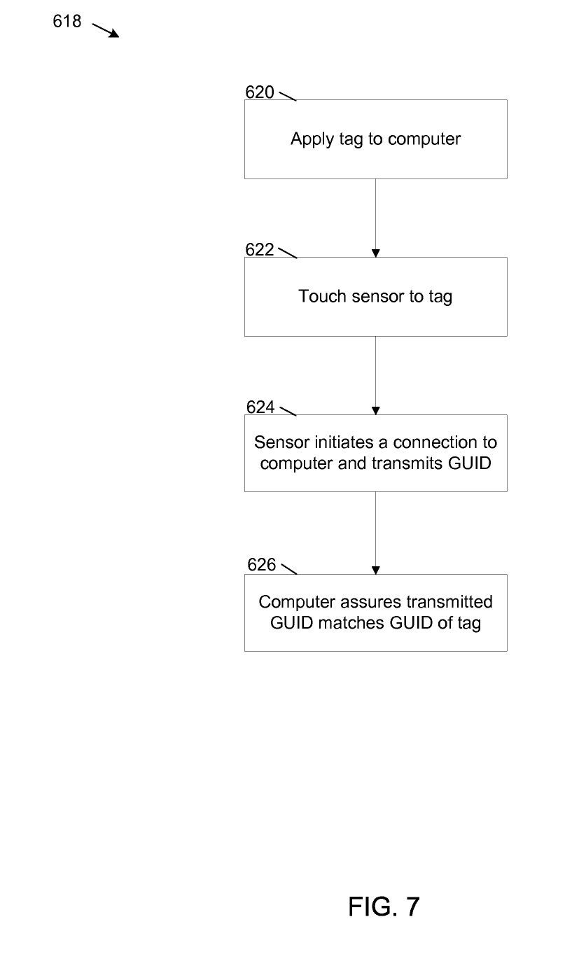

FIG. 7 illustrates an example an example method 618 for using a tag, such as an NFC tag, to identify a computer during pairing of a sensor device. At operation 620, an NFC tag is applied to the computer that contains a globally unique identifier (GUID) and that GUID is provisioned into the computer. Next, at operation 622, 24, the sensor initiates a connection to the computer (based on its list of paired devices) and once the sensor makes a connection to the computer, the sensor transmits the GUID. At operation 626, the application on the computer ensures that the transmitted GUID matches the received GUID for confirmation that this proximal sensor is the correct sensor with which to have a communication session. If the GUIDs do not match, then the communication is terminated.

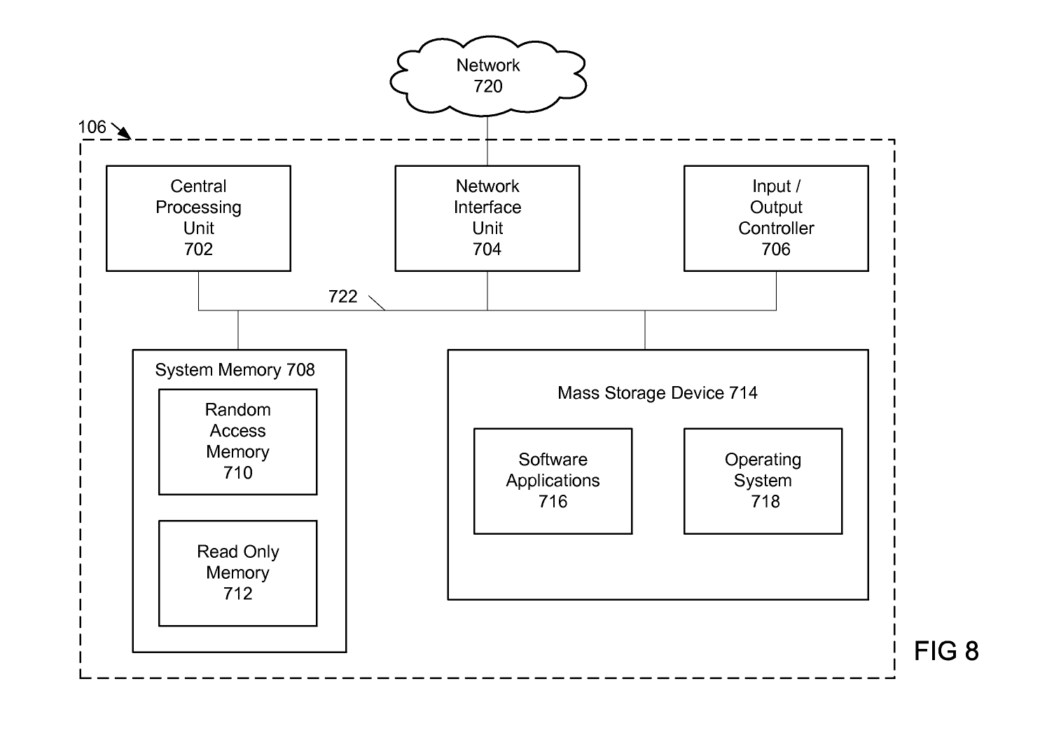

FIG. 8 illustrates example physical components of a patient monitor device, for example patient monitor device 106. As illustrated in the example of FIG. 8, patient monitor device 106 includes at least one central processing unit (“CPU”) 702, a system memory 708, and a system bus 722 that couples the system memory 708 to the CPU 702. The system memory 708 includes a random access memory (“RAM”) 710 and a read-only memory (“ROM”) 712. A basic input/output system contains the basic routines that help to transfer information between elements within the patient monitor device 106, such as during startup, is stored in the ROM 712. The patient monitor device 106 further includes a mass storage device 714. The mass storage device 714 is able to store software instructions and data.

The mass storage device 714 is connected to the CPU 702 through a mass storage controller (not shown) connected to the bus 722. The mass storage device 714 and its associated computer-readable data storage media provide non-volatile, non-transitory storage for the patient monitor device 106. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the patient monitor device 106.

According to various embodiments of the invention, the patient monitor device 106 may operate in a networked environment using logical connections to remote network devices through the network 720, such as a local network, the Internet, or another type of network. The patient monitor device 106 may connect to the network 720 through a network interface unit 704 connected to the bus 722. It should be appreciated that the network interface unit 704 may also be utilized to connect to other types of networks and remote computing systems. The patient monitor device 106 also includes an input/output controller 706 for receiving and processing input from a number of other devices, including a keyboard, a mouse, a touch user interface display screen, or another type of input device. Similarly, the input/output controller 706 may provide output to a touch user interface display screen, a printer, or other type of output device.

As mentioned briefly above, the mass storage device 714 and the RAM 710 of the patient monitor device 106 can store software instructions and data. The software instructions include an operating system 718 suitable for controlling the operation of the patient monitor device 106. The mass storage device 714 and/or the RAM 710 also store software instructions, that when executed by the CPU 702, cause the patient monitor device 106 to provide the functionality of the patient monitor device 106 discussed in this document. For example, the mass storage device 714 and/or the RAM 710 can store software instructions that, when executed by the CPU 702, cause the patient monitor device 106 to display received physiological data on a display screen of the patient monitor device 106.

The physical components shown in FIG. 8 may also apply to an electronic device, for example to electronic devices 110, 112 and to a server computer, for example to a server computer in EHR system 114.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A method implemented on an electronic device for pairing patient records with a patient identifier, the method comprising:
programming a smart tag with the patient identifier;
attaching the smart tag on an item associated with a patient;
reading the patient identifier from the smart tag, the reading of the patient identifier from the smart tag activating a software application on the electronic device for reading the patient records; and
after the patient identifier is obtained, on the electronic device, automatically accessing one of the patient records using the patient identifier.

2. The method of claim 1, wherein the item associated with the patient is a patient chart in a medical facility.

3. The method of claim 1, wherein the item associated with the patient comprises one of a patient bed, a door frame in a room in which the patient is located in a medical facility and an item that the patient is wearing.

4. The method of claim 1, wherein the smart tag is a radio frequency identification (RFID) tag or a near-field communication (NFC) device.

5. The method of claim 1, wherein the electronic device is a smart telephone or a tablet computer.

6. The method of claim 1, wherein using the electronic device to obtain the patient identifier from the smart tag comprises moving the electronic device into close proximity with the smart tag.

7. The method of claim 1, further comprising:
determining an identity of a user of the electronic device; and
rendering a view of the one patient record on the electronic device based on the identity of the user of the electronic device.

8. The method of claim 1, further comprising:
using the electronic device to read data from a medical sensor device used by the patient, the electronic device using radio frequency (RF) communication to read the data.

9. The method of claim 8, wherein the RF communication is near-field communication (NFC) or a body area network (BAN).

10. The method of claim 8, further comprising:
storing in the patient record the data read from the medical sensor device.

11. The method of claim 1, further comprising:
receiving patient data at the electronic device; and
storing the patient data in the patient record.

12. A method implemented on an electronic device for pairing patient records with a patient identifier, the method comprising:
using the electronic device to access a server computer to obtain the patient identifier;
after the patient identifier is obtained, touching the electronic device to a smart tag, the smart tag being connected to a patient monitor device, the touching of the electronic device to the smart tag transferring the patient identifier to the smart tag;
after the patient identifier is transferred to the smart tag, automatically obtaining one of the patient records from the server computer, the one patient record being identified by the patient identifier; and
displaying the patient record on the patient monitor device.

13. The method of claim 12, wherein transferring the patient identifier to the smart tag comprises programming the smart tag with the patient identifier.

14. The method of claim 12, wherein using the electronic device to access the server computer comprises:
activating a software application on the electronic device for accessing patient information;
accessing the server computer from the electronic device;
entering or speaking a patient name into the electronic device;
receiving the patient identifier from the server computer; and
displaying the patient identifier on the electronic device.

15. The method of claim 12, wherein the smart tag is wired to the patient monitor device.

16. The method of claim 12, wherein the patient identifier is transferred to the smart tag using near-field communication (NFC).

17. The method of claim 12, wherein the patient identifier is transferred to the smart tag using a body area network (BAN).

18. The method of claim 12, further comprising receiving patient data at the electronic device and updating the patient record with the received patient data.

19. A system for accessing patient records, the system comprising:
an NFC tag, the smart tag storing a patient identifier, the smart tag being a radio frequency identification (RFID) device or a near-field communication (NFC) device; and
an electronic device, the electronic device configured to read the patient identifier from the smart tag, the electronic device including software for interpreting data from the smart tag, the electronic device providing connectivity to a patient data server computer,
wherein the connectivity is automatically provided when the patient identifier is read from the smart tag, wherein the connectivity permits a patient record to be obtained from the patient data server computer based on the patient identifier and wherein the electronic device is configured to display the patient record on the electronic device.

20. The system of claim 19, wherein the electronic device updates the patient record after receiving new patient data.

21. A system for communicating between a first device, having a unique identifier, and a second device for the purpose of transmitting data from the first device via the second device to a database, the system comprising
a Near Field Communication (NFC) tag being programmed to store the unique identifier of the first device, the NFC tag being positioned adjacent to the first device;
a tag reader programmed to read the unique identifier from the NFC tag and provide the unique identifier to the second device;
wherein the second device uses the unique identifier to create a communication link between the second device and the first device.

22. The system of claim 21, wherein the first device is a computer and the second device is a sensor.

23. The system of claim 22, wherein the unique identifier is a global unique identifier, and the global unique identifier is a media access control address of a radio in the computer.

24. The system of claim 21, wherein the first device is a cellular telephone and the second device is a sensor.

25. The system of claim 21, further comprising the database, wherein the database is an electronic health record.

26. The system of claim 21, where the system ensures that the transmitted unique identifier from the second device matches the unique identifier of the first device, allowing communication to continue only when the transmitted unique identifier and the unique identifier of the first device match.
